(19) United States
(12) Patent Application Publication
(10) Pub. No.: US 2007/0171154 A1
(43) Pub. Date: Jul. 26, 2007

(54) METHOD AND APPARATUS FOR CREATING SEQUENCED MOTION USING ELECTROLUMINESCENCE

(75) Inventors: Timothy J. Collins, Homer Glen, IL (US); Marc K. Chason, Schaumburg, IL (US); Krishna Kalyanasundaram, Elmhurst, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,689

(22) Filed: Jan. 24, 2006

(51) Int. Cl. G09G 3/30

(52) U.S. Cl. 345/76

(57) ABSTRACT

An apparatus includes a top plate [245] of a first transparent conductive material, a middle plate [225] of a second transparent conductive material, and a bottom plate [205] of conductive material. At least one upper dielectric layer [240] is disposed between the top plate [245] and the middle plate [225], and at least one lower dielectric layer [215] disposed between the bottom plate [205] and the middle plate [225]. A first electroluminescent layer [235] is disposed between the top plate [245] and the middle plate [225]. The first electroluminescent layer [235] has a first predetermined pattern. A second electroluminescent layer [215] is disposed between the middle plate [225] and the bottom plate [205]. The second electroluminescent layer [215] has a second predetermined pattern. The first electroluminescent layer [235] and the second electroluminescent layer [215] are powered by at least one alternating current (AC) power source to selectively display a simulated motion.

### TECHNICAL FIELD

This invention relates generally to the use of electroluminescence to create sequenced motion.

### BACKGROUND

New technologies allow posters to be electrically excited with illumination to modify their appearance. Typically the excitation is sequenced to create greater visual appeal and to display motion. An example of an illumination providing a great level of visual appeal is an illumination displaying a 3-dimensional (“3-D”) effect.

Lenticular printing and electroluminescent signs are used as low-cost motion simulators today. Unfortunately, both of these technologies have drawbacks in simulating a 3-D effect. For example, lenticular printing designs are not emissive and therefore only have a limited range of about one foot for showing motion. Also, they only offer a significantly limited range of motion, typically about five discrete motion steps. Lenticular printing designs are further deficient in that they require the intervention of a physical tilt to simulate the motion.

The electroluminescent signage currently being used in the art typically have a single layer of electroluminescent material for displaying a pattern. The current state of electroluminescent signage, however, cannot simulate a dynamic 3-D motion, at least in part, because current electroluminescent designs utilize only this single layer of electroluminescent material.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an electroluminescent sign according to the prior art;

FIG. 2 illustrates a side view of a display having electroluminescent layers according to an embodiment of the invention;

FIG. 3 illustrates a first image of a beer being poured from a beer bottle into a beer mug according to an embodiment of the invention;

FIG. 4 illustrates a second image of a beer being poured from a beer bottle into a beer mug according to an embodiment of the invention;

FIG. 5 illustrates a third image of a beer being poured from a beer bottle into a beer mug according to an embodiment of the invention;

FIG. 6 illustrates a fourth image of a beer being poured from a beer bottle into a beer mug according to an embodiment of the invention;

FIG. 7 illustrates a fifth image of a beer being poured from a beer bottle into a beer mug according to an embodiment of the invention; and

FIG. 8 illustrates a side view of a display having electroluminescent layers according to an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, an electroluminescent poster/sign is provided that utilizes two or more separate electroluminescent layers. The electroluminescent layers may each include various patterns drawn/depicted with electroluminescent inks. When an alternating current (AC) is applied to one of the patterns, the electroluminescent inks contained therein emit visible light.

Multiple different patterns may be disposed on each of the electroluminescent layers. The patterns may, e.g., be sequentially excited to show the illusion of physical movement. The use of multiple electroluminescent layers allows for the display of a 3-D effect, providing an exciting visual display visual that need not be viewed only from a very short distance, such as 30 centimeters, to be perceived.

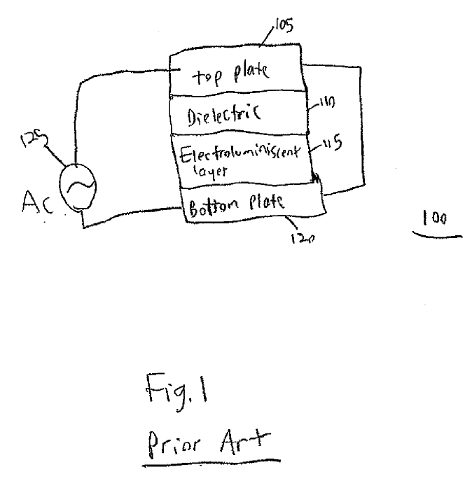

As noted earlier, the current state of electroluminescent signage cannot simulate a dynamic 3-D motion, at least in part, because current electroluminescent designs utilize only a single layer of electroluminescent material. FIG. 1 illustrates an electroluminescent sign 100 according to the prior art. As shown, the electroluminescent sign 100 includes a top plate 105, a dielectric 110, an electroluminescent layer 115, and a bottom plate 120. An Alternating Current (“AC”) power source 125 provides power to the electroluminescent sign 100. Because only one electroluminescent layer is utilized, however, it is not possible to simulate a dynamic 3-D motion.

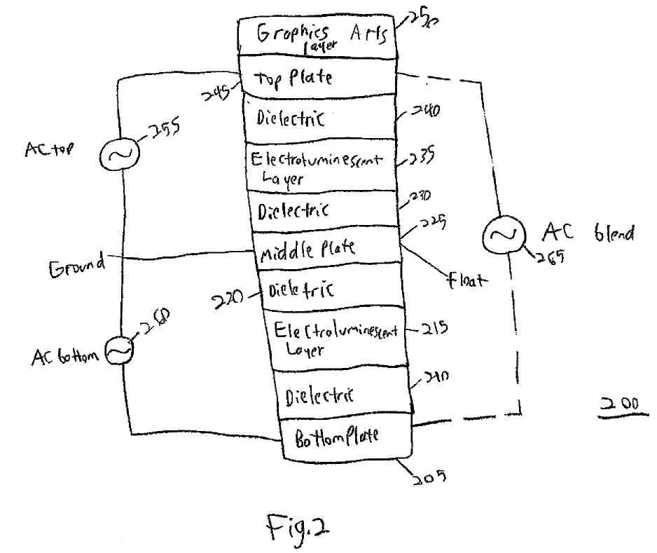

FIG. 2 illustrates a side view of a display 200 having electroluminescent layers according to an embodiment of the invention. As shown, a bottom plate 205 is located at the bottom of the display 200. Above the bottom plate 205 is a dielectric 210. The dielectric 210 is an insulator, i e., a non-conductor of electricity. An electroluminescent layer 215 is disposed on the dielectric 210, and another dielectric 220 is disposed on the other side of this electroluminescent layer 215. In other embodiments, only a single dielectric layer is utilized instead of two dielectrics 210, 220.

The electroluminescent layer 215, by one approach, comprises electroluminescent ink printed, drawn or otherwise deposited or disposed on a transparent material. The electroluminescent ink is conductive and emits light when electric current flows through it or a sufficient electric field is in its presence. An electroluminescent device having electroluminescent ink is similar to a light emitting diode (LED) or laser in that photons are produced by the return of an excited substance to its ground state, but unlike lasers electroluminescent devices require much less energy to operate and do not produce coherent light.

There are four steps necessary to produce electroluminescence in the electroluminescent layer 215: first, electrons travel or tunnel from electronic states at the interface between the dielectric 220 and the electroluminescent ink, which may be, e.g. phosphor. Second, electrons are accelerated to ballistic energies by high fields in the electroluminescent ink. Next, the energetic electrons impact-ionize a luminescence center or create electron-hole pairs that lead to the activation of the luminescent center. Finally, the luminescent center relaxes toward the ground state and emits a photon.

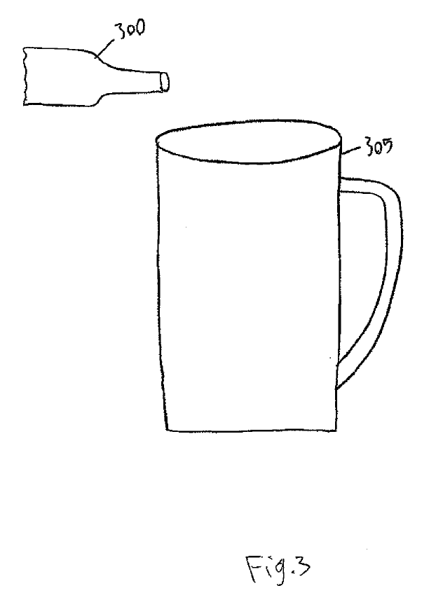

With continued reference to FIG. 2, by one approach a middle plate 225 is located above the dielectric 220. Another dielectric 230 is disposed on top of the middle plate 225, and an electroluminescent layer 235 is disposed on top of the dielectric 230. Yet another dielectric 240 is disposed above the latter electroluminescent layer 235, and a top plate 245 is disposed above this dielectric 240. Finally, in this illustrative embodiment, a graphics arts layer 250 is located above the top plate 245. The graphics arts layer 250 may include an opaque or translucent, i.e., partially opaque drawing/design. For example, the graphics arts layer 250 may include an image of a beer bottle, as shown below with respect to FIGS. 3-7. The graphics arts layer 250 may effectively join traditional graphic arts printing, laser printing, etc., with the upper electroluminescent layer 235 and the lower electroluminescent layer 215 to display a visually exciting image.

The middle plate 225 and the top plate 245 may each be formed of a transparent conductive material. For example, the middle plate 225 and the top plate 245 may be formed of indium tin oxide. The bottom plate 205 is also conductive and is transparent in some embodiments. In other embodiments, the bottom plate is not transparent.

By utilizing multiple electroluminescent layers, i.e., electroluminescent layer 215 and electroluminescent layer 235, multiple brightness levels/colors may be produced in the display 200. Those skilled in the art will appreciate that additional electroluminescent layers may be provided as desired and that only two are shown here for the sake of simplicity and clarity. The display 200 is powered so that either of the first electroluminescent layer 215 or the second electroluminescent layer 235 may selectively emit light. In one embodiment, the top plate 245 and the bottom plate 205 are separately powered by an Alternating Current (“AC”) top source 255 and an AC bottom source 260, in which case the middle plate 225 is coupled to a ground reference. If desired, such layers may be separately powered so that one of the layers may be switched on while the other is switched off, and/or to provide a range of different tones. Again, it should be appreciated that although only two electroluminescent layers are shown, additional fully or partially overlying electroluminescent layers may also be utilized, depending on the particular application.

Phosphor particles in the electroluminescent ink are electrically excited to produce light and the intensity can be controlled by the voltage and frequency of the AC power supply. Various patterns can be made with the electroluminescent ink included on electroluminescent layer 215 and electroluminescent layer 235. The patterns may then be selectively powered to emit light in the selected pattern.

In another embodiment, a single AC blended power source 265 may be utilized, instead of the AC top source 255 and the AC bottom source 260, as shown by the phantom lines in FIG. 2. By utilizing the AC blended power source 265, it may be possible to create a visual blending of the electroluminescent ink of the first electroluminescent layer 215 with the electroluminescent ink of the second electroluminescent layer 235. That is, part of the electroluminescent ink of the second electroluminescent layer 235 may overlap with part of the ink of the first electroluminescent layer 215 when both are powered. The resultant combination of colors at the overlapping portions may selectively produce a resultant color that may not be otherwise achievable when using only one of these electroluminescent layers 235 and 215. When the single AC blended power source 265 is utilized, the middle plate 225 may be configured as a floating reference level instead of being grounded as it is when the separate AC top power source 255 and the AC bottom power source 260 are utilized. Alternatively, the AC top power source 255 and the AC bottom power source 260 may be active at the same time rather than being sequentially activated.

In the embodiments described above, the brightness levels/colors emitted by the electroluminescent ink may be altered by changing the oscillation frequency of the AC power supplied. For example, a faster oscillation may result in higher emitted brightness levels/colors and a slower oscillation may result in lower emitted brightness levels/colors. The changing of the frequency of the AC power directly changes the brightness level.

Those skilled in the art will recognize and understand that, as used herein, terms such as “above” or “on top” are used for illustrative purposes only, with an assumption being made that the bottom plate 205 is located at the bottom of the display 200 and the graphics arts layer 250 is located at the top of the display 200. Such an orientation, however, serves for purposes of convenient illustration rather than as a specific limitation. It should be appreciated that the entire display 200 may be tilted or turned as desired, thereby changing the orientations of the various layers of the display 200. For example, the display 200 may be tilted 180 degrees such that the bottom plate 205 is located at the top of the display and graphics arts layer 250 is located at the bottom of the display 200.

The electroluminescent ink is known as a “functional” ink because its operational properties can vary with respect to one or more conditions. For example, as discussed above, the frequency of an AC current supplied to the functional ink may be varied to change a brightness level emitted by the functional ink.

FIGS. 3-7 illustrate an image of a beer being poured from a beer bottle 300 into a beer mug 305 according to an embodiment of the invention. The beer bottle 300 and the beer mug 305 may be depicted on or drawn on the graphics arts layer 250 shown above with respect to FIG. 2. As discussed above, a portion of the image of the beer bottle 300 and the beer mug 305 may be opaque or substantially opaque. The beer bottle 300 and the beer mug 305 form an outline of an image to which 3-D movement will be depicted, as discussed below. Those skilled in the art will realize that images other than beer and beer bottles can be depicted and that other motions may also be simulated.

The appearance of 3-D movement is depicted through the actuation of multiple drawings or patterns made with electroluminescent ink. Specifically, multiple patterns may be included on one, or both, of the first electroluminescent layer 215 and the second electroluminescent layer 235. The patterns are then selectively activated to emit visible light. The sequence in which the patterns are activated can give the appearance of dynamic movement.

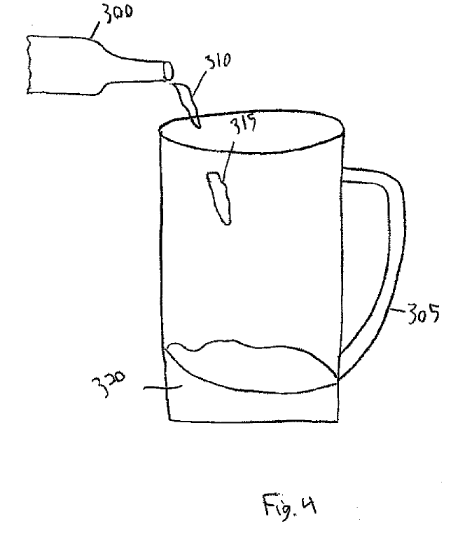

FIG. 4 illustrates the display of a first set of patterns made with electroluminescent inks. As shown, a first drop 310 and a second drop 315 of beer are shown pouring out of the beer bottle 300. At the bottom of the beer mug 305 is a first image 320 of collected beer. The collected beer 320 is intended to be perceived as the collection of beer drops poured from the beer bottle 300. The first drop 310 and the second drop 315 may have a different brightness level or color than the first image 320 of the collected beer. For example, the first drop 310 and the second drop 315 may have a brighter brightness level/color than the first image 320 of the collected beer, or vice-versa. The first drop 310 and the second drop 320 may both be drawn with electroluminescent ink on the first electroluminescent layer 215, and the first image 320 of the collected beer may be drawn with electroluminescent ink on the second electroluminescent layer 235. Alternatively, the first drop 310 and the second drop 320 may both be drawn with electroluminescent ink on the second electroluminescent layer 235 and the first image 320 of the collected beer may be drawn with electroluminescent ink on the first electroluminescent layer 215.

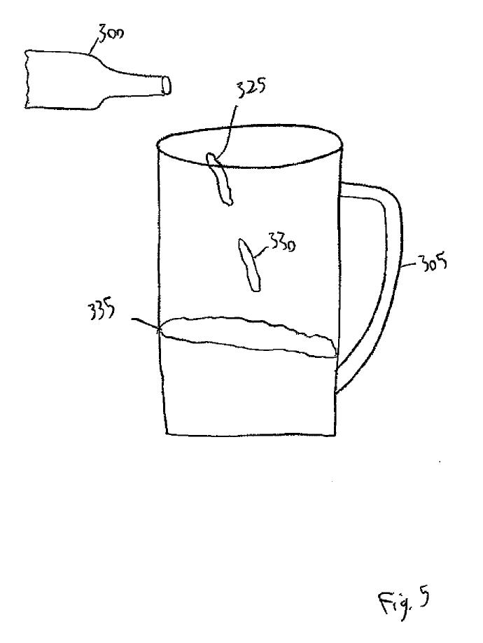

FIG. 5 illustrates the display of a second set of patterns made with electroluminescent inks. As shown, a third drop 325 and a fourth drop 330 of beer are shown pouring out of the beer bottle 300. At the bottom of the beer mug 305 is a second image 335 of collected beer. As with FIG. 4, the second image 335 of collected beer is intended to be perceived as the collection of beer poured from the beer bottle 300. The third drop 325 and the fourth drop 330 may have a different brightness level or color than the second image 335 of the collected beer. The third drop 325 and the fourth drop 330 may also have different brightness levels or colors than the first drop 310 and the second drop 315 discussed above.

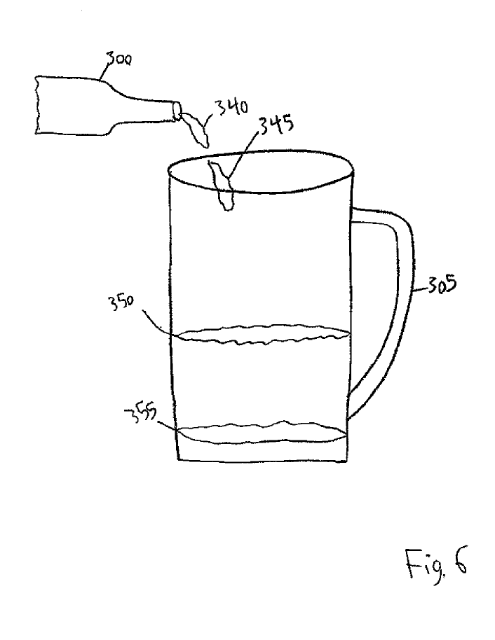

FIG. 6 illustrates the display of a third set of patterns made with electroluminescent inks. As shown, a fifth drop 340 and a sixth drop 345 of beer are shown pouring out of the beer bottle 300. At the bottom of the beer mug 305 are a third image 350 and a fourth image 355 of collected beer. As with FIGS. 4 and 5, the third image 350 and the fourth image 355 of collected beer are intended to be perceived as the collection of beer poured from the beer bottle 300. The fifth drop 340 and the sixth drop 345 may have a different brightness level or color than the third image 350 and/or the fourth image 355 of the collected beer. The fifth drop 340 and the sixth drop 345 may also have a different brightness level or color than the first drop 310, the second drop 315, the third drop 325, and the fourth drop 330 discussed above.

For example, the first drop 310 and the second drop 315 may have a brighter brightness level/color than the first image 320 of the collected beer, or vice-versa. The first drop 310 and the second drop 320 may both be printed, etched or drawn with electroluminescent ink on the first electroluminescent layer 215, and the first image 320 of the collected beer may be printed etched or drawn with electroluminescent ink on the second electroluminescent layer 235. Alternatively, the first drop 310 and the second drop 320 may both be printed etched or drawn with electroluminescent ink on the second electroluminescent layer 235, and the first image 320 of the collected beer may be printed etched or drawn with electroluminescent ink on the first electroluminescent layer 215.

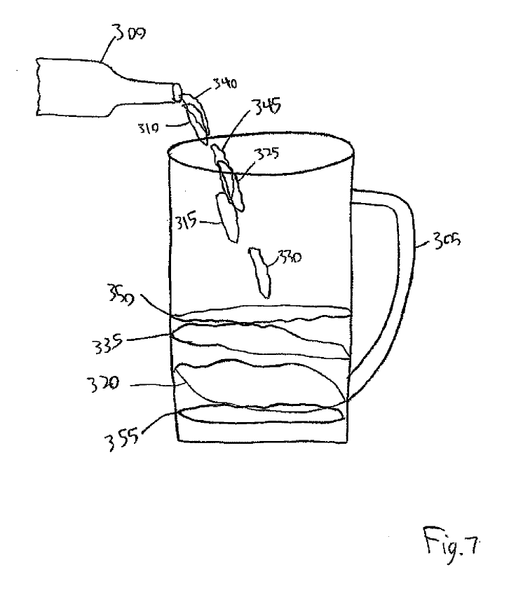

FIG. 7 illustrates the display when all of the images drawn with electroluminescent ink shown in FIGS. 3-6 are displayed. As shown, the first drop 310, second drop 315, third drop 325, fourth drop 330, fifth drop 340, and sixth drop 345 may all be displayed simultaneously. Each of the drops may have a slightly different brightness level and the drops may be incrementally displayed, or alternatively displayed to depict the appearance that beer is pouring into the beer mug 305. For example, the first drop 310, second drop 315, third drop 325, and fourth drop 330 may be displayed, and subsequently the fifth drop 340 and the sixth drop 345 may be displayed. However, when the fifth drop 340 and the sixth drop 345 are displayed, the displayed pattern of the first drop 310 may stop being activated such that the first drop 310 is no longer being displayed.

Similarly, the first image 320, second image 335, third image 350, and fourth image 355 may all be simultaneously displayed or incrementally displayed to depict the appearance of the beer mug 305 filling with beer. Moreover, some, or all, of the first image 320, second image 335, third image 350, and fourth image 355 may have different brightness levels/colors to present the appearance of depth in the display, i.e., to appear as a 3-D image.

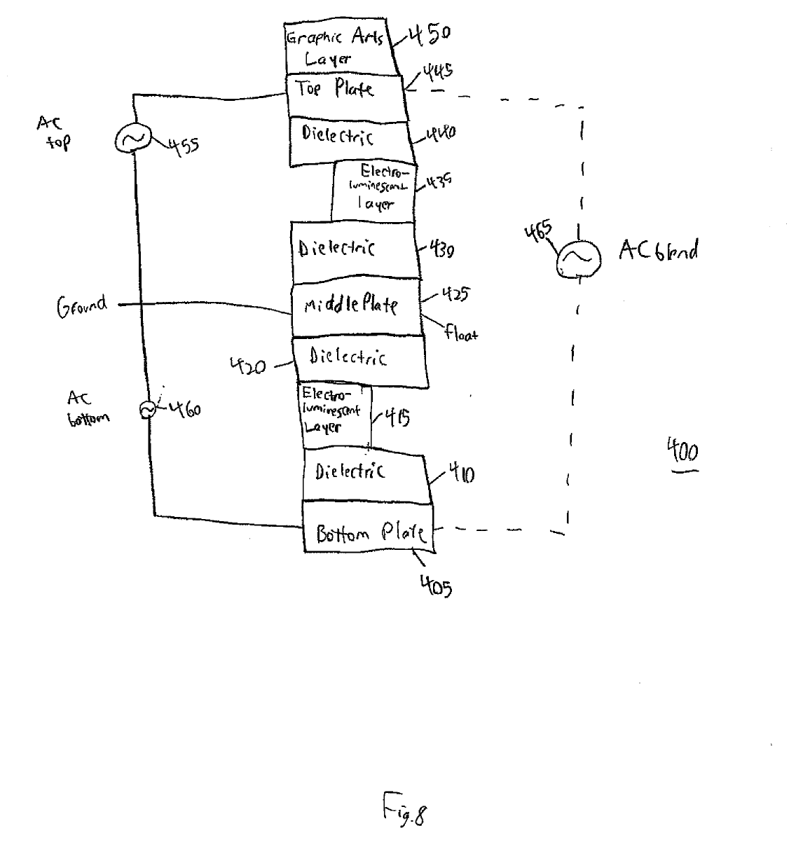

FIG. 8 illustrates a side view of a display 400 according to an embodiment of the invention. The display 400 is similar to the display 200 shown in FIG. 2, with the exception that unlike in FIG. 2, a lower electroluminescent layer, i.e., electroluminescent layer 415, is not substantially entirely overlapped by an upper electroluminescent layer 435. Therefore, a partial blend of colors contained on both the lower electroluminescent layer 415 and the upper electroluminescent layer 435 is possible, and a pattern showing only a printing, an etching or drawing contained on the upper electroluminescent layer 435, and another pattern shown only on the lower electroluminescent layer 415 is possible.

As shown in FIG. 8, a bottom plate 405 is located at the bottom of the display 400. Above the bottom plate 405 is a dielectric 410. The lower electroluminescent layer 415 is disposed on the dielectric 410 and another dielectric 420 is disposed on the other side of the lower electroluminescent layer 415. The gap to the side of the lower electroluminescent layer 415 may be filled with dielectric material from dielectric 410 or dielectric 420. Similarly for the upper electroluminescent layer 435, the gap may be filled with dielectric material from dielectric 430 or dielectric 440.

In this embodiment the lower electroluminescent layer 415 includes electroluminescent ink drawn or disposed on a transparent material. A middle plate 425 is located above the dielectric 420. Another dielectric 430 is disposed on top of the middle plate 425, and the upper electroluminescent layer 435 is disposed thereon. Another dielectric 440 is disposed above the upper electroluminescent layer 435, and a top plate 445 is disposed above the dielectric 440. Finally, a graphics arts layer 450 is located above the top plate 445. As with display 200 shown in FIG. 2, the graphics arts layer 450 may include an opaque or partially opaque drawing/design.

The middle plate 425 and the top plate 445 may each be formed of a transparent electrically conductive material. For example, the middle plate 425 and the top plate 445 may be formed of indium tin oxide. Bottom plate 405 is formed of an electrically conductive material (e.g., aluminum, copper, nickel, gold, indium tin oxide) and may or may not be transparent.

By utilizing multiple electroluminescent layers, i.e., the lower electroluminescent layer 415 and the upper electroluminescent layer 435, multiple brightness levels/colors may be produced in the display 400.

In another embodiment, a single AC blended power source 465 may be utilized as shown using phantom lines in FIG. 8, instead of the AC top source 455 and the AC bottom source 460. By utilizing the AC blended power source 465, it may be possible to create a partial visual blending of the electroluminescent ink of the lower electroluminescent layer 415 with the electroluminescent ink of the upper electroluminescent layer 435. That is, a small portion of the ink of the lower electroluminescent layer 415 may overlap with part of the ink of the upper electroluminescent layer 435 when both are powered. So configured, the combination of colors at the overlapping portions may produce a resultant color that is not possible when using only one of the upper electroluminescent layer and the lower electroluminescent layer. When the single AC blended power source 465 is utilized, the middle plate has a floating reference level, and instead of being grounded as it is when the separate AC top power source 455 and the AC bottom power source 460 are utilized. Alternatively, the AC top power source 455 and the AC bottom power source 460 may be active at the same time rather than sequentially.

Accordingly, pursuant to the various embodiments described above, an electroluminescent poster/sign is provided that utilizes two or more separate electroluminescent layers. The electroluminescent layers may each include various patterns printed, drawn/depicted with electroluminescent inks. When an AC current is applied to one of the patterns, the electroluminescent inks contained therein emit visible light.

Multiple different patterns may be disposed on each of the electroluminescent layers. The patterns may, e.g., be sequentially excited to show the illusion of physical movement. The use of multiple electroluminescent layers allows for the display of a 3-D effect, providing an exciting visual display that may be satisfactorily viewed from other than a very short distance. Those skilled in the art will appreciate that these teachings can be employed in a relatively cost effective manner and therefore present a highly leverageable opportunity for a relatively wide variety of users.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus, comprising:
a top plate of a first transparent conductive material;
a middle plate of a second transparent conductive material;
a bottom plate of conductive material;
at least one upper dielectric layer disposed between the top plate and the middle plate;
at least one lower dielectric layer disposed between the bottom plate and the middle plate;
a first electroluminescent layer disposed between the top plate and the middle plate, the first electroluminescent layer having a first predetermined pattern;
a second electroluminescent layer disposed between the middle plate and the bottom plate, the second electroluminescent layer having a second predetermined pattern; and
wherein the first electroluminescent layer and the second electroluminescent layer are powered by at least one alternating current (AC) power source to selectively display a simulated motion.

2. The apparatus of claim 1, wherein at least one of the top plate and the middle plate is comprised of at least one of an indium tin oxide and a electron-conducting ink.

3. The apparatus of claim 1, wherein the at least one AC power source has a frequency that is variable to cause at least one of the first electroluminescent layer and the second electroluminescent layer to emit a range of different brightness levels.

4. The apparatus of claim 1, further comprising a graphics arts layer disposed on the top plate, wherein at least a portion of the graphic arts layer is translucent.

5. The apparatus of claim 4, wherein the graphics arts layer is comprised of a non-functional ink.

6. The apparatus of claim 1, wherein the at least one AC power source comprises a first AC power source to provide power to the top plate and a second AC power source to provide power to the bottom plate.

7. The apparatus of claim 4, wherein the middle plate is in communication with a ground reference.

8. The apparatus of claim 1, wherein the at least one AC power source comprises a single AC power source to provide power to the top plate and the bottom plate.

9. The apparatus of claim 1, further comprising a third electroluminescent layer powered by the at least one AC power source.

10. The apparatus of claim 1, wherein at least a portion of the first electroluminescent layer overlaps the second electroluminescent layer.

11. An apparatus, comprising:
a top plate of a first transparent conductive material;
a middle plate of a second transparent conductive material;
a bottom plate of conductive material;
at least one upper dielectric layer disposed between the top plate and the middle plate;
at least one lower dielectric layer disposed between the bottom plate and the middle plate;
a first electroluminescent layer disposed between the top plate and the middle plate, the first electroluminescent layer having a first predetermined pattern;
a second electroluminescent layer disposed between the middle plate and the bottom plate, the second electroluminescent layer having a second predetermined pattern;
wherein at least a portion of the first electroluminescent layer has no overlap with the second electroluminescent layer.

12. The apparatus of claim 11, wherein the first electroluminescent layer and the second electroluminescent layer are powered by at least one alternating current (AC) power source to selectively display a simulated motion.

13. The apparatus of claim 12, wherein the at least one AC power source has a frequency that is variable to cause at least one of the first electroluminescent layer and the second electroluminescent layer to emit a range of different brightness levels.

14. The apparatus of claim 11, further comprising a graphics arts layer disposed on the top plate, wherein at least a portion of the graphic arts layer is translucent.

15. The apparatus of claim 12, wherein the at least one AC power source comprises a first AC power source to provide power to the top plate and a second AC power source to provide power to the bottom plate.

16. The apparatus of claim 12, wherein the simulated motion comprises 3-Dimensional motion.

17. The apparatus of claim 12 wherein the first electroluminescent layer and the second electroluminescent layer at least partially overlap.

18. A method, comprising:
providing first alternating current (AC) power to a first electroluminescent layer of an apparatus, the first electroluminescent layer having a first predetermined pattern;
providing second AC power to a second electroluminescent layer of an apparatus, the second electroluminescent layer having a second predetermined pattern;
wherein the first electroluminescent layer and the second electroluminescent layer are selectively powered to display a simulated motion.

19. The method of claim 18, wherein the simulated motion comprises 3-Dimensional motion.

20. The method of claim 18, further comprising displaying a graphics arts layer above the first electroluminescent layer and the second electroluminescent layer, wherein at least a portion of the graphic arts layer is translucent.
